(19) United States
(12) Patent Application Publication
(10) Pub. No.: US 2016/0275461 A1
(43) Pub. Date: Sep. 22, 2016

(54) AUTOMATED ATTESTATION OF DEVICE INTEGRITY USING THE BLOCK CHAIN

(71) Applicant: Rivetz Corp., Wilmington, DE (US)

(72) Inventors: Michael Sprague, New York, NY (US); Steven Sprague, Richmond, VA (US)

(21) Appl. No.: 15/074,784

(22) Filed: Mar. 18, 2016

Related U.S. Application Data
(60) Provisional application No. 62/136,340, filed on Mar. 20, 2015.
(60) Provisional application No. 62/136,385, filed on Mar. 20, 2015.

(51) Int. Cl. G06Q 20/06; H04L 9/30; G06Q 20/38; H04L 29/06; H04W 12/06; H04W 12/04; H04L 9/32; H04L 9/14

(52) U.S. Cl. CPC G06Q 20/0655; H04L 9/3239; H04L 9/3249; H04L 9/302; H04L 9/14; H04L 63/0823; H04W 12/06; H04W 12/04; H04L 63/06; G06Q 20/3829; H04L 2209/56; H04L 2209/80; G06Q 2220/00

(57) ABSTRACT

Systems and methods are disclosed that provide for a full validation of an unknown client device prior to acceptance of a block chain transaction would provide further security for block chain transactions. The health of the device can be attested to prior to engaging in electronic transactions. In some embodiments, automation of full device integrity verification is provided as part of a block chain transaction. Certain aspects of the invention enable trust in devices. Some embodiments operate on the fundamental premise that a reliable relationship with a device can make for a much safer, easier and stronger relationship with an end user. Achieving this requires knowing with confidence that a device involved in a current transaction is the same device it was in previous transactions.

### RELATED APPLICATION

This application claims the benefit of U.S. Provisional Application No. 62/136,340 filed on Mar. 20, 2015 and U.S. Provisional Application No. 62/136,385 filed on Mar. 20, 2015. The entire teachings of the above applications are incorporated herein by reference.

### BACKGROUND

The advent of decentralized transaction systems such as Bitcoin has provided the Internet with a reliably secure protocol for recording ownership over digital value known as the block chain. The system is rooted in private keys that enable people to exercise that digital value. However, when these keys are stored digitally, and particularly when they are transacted, they are vulnerable to theft which can result in substantial losses. Industry has for years anticipated a need for high-assurance operations in endpoint devices. Already deployed hardware security can be used to enhance the security and privacy for interactions between people and the block chain.

The block chain behind Bitcoin, the common ledger that is built on the backs of thousands of peered servers, is devised to be mathematically impenetrable. As long as a majority of participating peers act in support of the community one cannot leverage enough compute power to edit records of the past and thus steal value. With such a large community maintaining its integrity, it is deemed that only a vulnerability in elliptic curve cryptography could compromise the block chain. However, while the block chain itself is well secured, how an individual transacts with it is either very complex or subject to a number of well-known malware attacks. The result is that the quality of the instructions to the block chain are critical to assuring the quality of the protected transaction ledger.

### SUMMARY

Most of the transactions captured in the Bitcoin block chain record a transfer of value from one person to another. Public keys represent the parties involved. Corresponding private keys enable a participant to claim the result. As there is no other method of oversight or control, it is paramount that the private key be secured. The block chain is an ephemeral construct. People can only interact with it through their control of a network connected device. Broadly speaking there are three ways in which this takes place. A) The person controls a machine that is itself a peer and writes directly into the block chain. B) The person uses a web site or mobile app to instruct a server acting on their behalf, or C) the person uses a web site or app to propagate a transaction that is locally formed.

In general, a private key is applied to sign a request. The execution environment is responsible for the accuracy of the request and protection of the private key. Attestation to the health and origin of the execution environment establishes its reliability.

There are a number of widespread tools that can be leveraged for improving the security of the execution environment. This ranges from hardware backed device identity to full trusted execution environments. The consumer web is the most broadly distributed services platform that is constructed on user identification methods rather than device identification. Unlike mobile telephony or cable television, for example, where service is authenticated by the enabling device, the web requires that end-users conduct the identification protocol, i.e. enter username and password. While there are benefits to the portability of this method, it is dangerously susceptible in practice. Users are terrible at remembering complex passwords and irritated by repetitive requests. The result is passwords like “GoYanks” and session keys that are allowed to persist for days. A device, on the other hand, will happily engage in a cryptographic authentication well beyond the capacity of any human with any of thousands of credentials stored in its hardware. And it will do it over and over without fatigue.

Except in extreme circumstances, portability in the form of username/password, has a role to play. But most of the time users engage with the same devices for the same interactions. By leveraging the devices they own to conduct basic authentication this consistency can be rewarded with immediate access for users and increased assurance for service providers.

The Internet is largely accessed by multi-purpose devices. PC's, Tablets and Phones may host hundreds of applications and the vibrant market for new apps drives a very open environment. This is very user friendly until one of those apps disguises a malicious intent and begins to vandalize or steal from the other apps on the device. In addition to knowing whether the device is the same one it was before, a service provider should ask it, are you in the same state as before. When significant changes are known to have occurred this can indicate a potential threat. This knowledge enables service providers to take remedial action or at least request further confirmation from the device operator that the machine is still safe.

The user will often not know if their device is compromised, but if it can be detected, for example, that the BIOS has changed, a service can take cautionary steps.

Installing and running apps is meant to be very simple. However, there is a class of apps that can benefit greatly from strong assurance of their origin and opaque separation from the execution of other apps. This may be, for example, a Trusted Execution Environment or TEE. Unlike an app running on the primary OS and memory stack, an app running in a TEE can have access to cryptographic primitives that can be exercised without snooping by the OS. In ideal circumstances it also has direct access to user input and display to ensure a private interaction with the operator of the device.

Both proprietary and standards based solutions in support of device security have worked their way into the supply chain. The Trusted Platform Module, or TPM, for instance, is a security chip embedded on the motherboard of most modern PC's. The technology is specified by the Trusted Computing Group (TCG), a non-profit consortium of dozens of major vendors. It was designed largely in support of enterprise network security but has a huge role to play in simplifying the consumer web. TPM's having be shipping for half a dozen years and are now widely prevalent in modern PC's. Microsoft logo compliance beginning in 2015 will further ensure that no machine is delivered without a TPM.

A TPM is relatively simple. It serves three basic purposes: PKI, BIOS integrity and encryption. While the technology has been pursued for well over a decade, it is only recently that devices with support for a TEE have become available. Intel began delivery of commercial solutions in 2011 and Trustonic launched in 2013. The platforms and associated tools are reaching the level of maturity required for consumer use. Deploying an app into a TEE is akin to delivering a dedicated hardware device. Execution and data are cryptographically isolated from any other function of the host.

The chip has no identity of its own, but can be asked to generate key pairs. AIK's, or Attestation Identity Keys, can be marked as “non-migratable” so that the private half of the key pair will never be visible outside the hardware. This provides an opportunity to establish a machine identity that cannot be cloned. Currently deployed TPM's, version 1.2, are limited to RSA and SHA-1. Version 2.0, coming soon, will be much more agile. The TPM also implements an Endorsement Key (EK). The EK is installed during manufacture and can be used to prove that the TPM is in a fact a real TPM. A system supporting a TPM will load Platform Configuration Registers (PCR's) during its boot sequence. Beginning with the firmware, each step in the boot process measures its state and the state of the next process and records a PCR value. As the PCR's are captured in the tamperproof TPM a reliable “quote” of the system's BIOS integrity can subsequently be requested. A PCR doesn't capture what actually happened it only captures, through a series of hashes, that nothing is changed. This is particularly important for protection against the most serious and otherwise undetectable attacks where a hacker compromises the machine bios or installs a secret hypervisor. Combined with an assurance signature from virus scanning software, one can establish a reliable state of machine health. TPM's also provide bulk encryption services. Encryption keys are generated in the TPM, but not stored there. Instead they are encrypted with a TPM bound Storage Root Key and returned to the requesting process. A process wishing to encrypt or decrypt a blob of data will first mount the desired key. The key is then decrypted in the hardware and made available for ciphering. As with most TPM keys, encryption keys can be further protected with a password if desired.

Trustonic (http://www.trustonic.com) is a joint venture of ARM, G+D and Gemalto. Trustonic provides a trusted execution environment across a broad array of smart devices. The goal is to enable the secure execution of sensitive application services. Trustonic is an implementation of the Global Platform standard for Trusted Execution Environments. Apps written to execute in the Trustonic TEE are signed and measured. Devices supporting Trustonic provide an isolated execution kernel so that a loaded app cannot be spied on by any other process running on the device, including debug operations on a rooted device. Trustonic was formed in 2012 and now ships with half a dozen manufactures and supports a couple dozen service providers. Over 200 million devices have now shipped with Trustonic support.

Intel vPro is collection of technologies built into modern Intel chip set. New machines marketed with vPro support the Intel TXT Trusted Execution Technology. Intel offers a secure processing environment in the Management Engine (ME) that enables protected execution of numerous cryptographic functions. One use of this capability has been the deployment of TPM 2.0 functionality implemented as an app in the ME. The Management Engine also supports secure display functions for conducting fully isolated communications with the user. In this manner an app executing in the ME can take direction from the user with a substantially reduced risk of compromise.

ARM TrustZone provides the silicon foundations that are available on all ARM processors. The primitives isolate a secured world of execution from the common execution space. ARM provides the designs that are then built into a number of standard processors. To take advantage of TrustZone, apps can either be deployed as part of system firmware by the manufacturer or can be delivered after the fact through third party tools like Trustonic, Linaro or Nvidia's open source micro kernel.

Some embodiments of the present invention apply these technologies into a set of services for enhancing the transaction environment that connects people and the block chain.

The concept of second factor authentication is well established though in limited use. It is perhaps utilized most prominently by Bitcoin service sites, where breaching a login can provide immediate and irreversible theft of funds. Most people are familiar with second factor in the form of a SMS confirmation or key fob. You enter your username and password and then you enter the code messaged to your registered phone. Second factor authentication is an important step for login security, however, it burdens the user with additional work. Even if we understand why it's important, mankind is naturally lazy. Many sites allow users to opt out of repeated confirmations and many users readily select this time saving degradation of security. A further example method, may be to first validate with the device from which the authentication request is sent. Using a TPM or any other secure source of cryptographic key sets, a web service can ask the device to prove it is the same device it was before. This request can be transparent to the user (or further secured with a PIN) and provides a level of assurance whereby hassling the user for identity and authentication can often be bypassed.

A machine generated cryptographic proof tends to be far more reliable than a short username and eight character password, both of which are probably based on memorable facts attributed to the user. The user is best relegated to the job of protecting the device. Ten thousand years of evolution has trained people to protect valuable objects. Yet we find it hard to remember even a ten digit phone number. Devices, on the other hand, are purpose-built for blazingly fast math. If a user finds him or herself without a regularly used device, the service can fall back on user identification procedures. When it's not the common use case a user will be willing to accept more onerous identification procedures.

According to an example embodiment of the invention, the first step of leveraging device identity is enrollment. In one preferred embodiment, device enrollment may be enacted under the oversight of some other trusted entity. For example, enrollment of a phone could take place at the point of sale where binding between the end user and the device identity can be established with physical presence. However, in many use cases this level of person-to-device association is neither necessary nor desired. Device identity and attributes that could be considered Personally Identifying Information (PII) should not be inextricably linked. Basic device identity is purely anonymous. To reliably enroll a device we only need two things: A) The ability to generate a key pair that is locked to the device, and B) assurance of the provenance and quality of the device environment that provides this service. The latter is provided either by social engineering or supply chain crypto. While nothing is absolute, a device registered in the presence of a respected purveyor is likely to be a real device. It is important to the lasting reputation of that purveyor. Trust in a device that is keyed on the manufacturing floor and can be confirmed with the OEM certificate authority, likewise, is built on the reputation of that manufacturer.

According to some embodiments, enrollment involves establishing a uniqueness which can be queried but not spoofed. For this, the TPM (or similar hardware root of trust) may be used. The TPM chip generates a key pair and returns the public portion of the key to the client which in turn posts it to a server. A random id is generated and together the couplet is transacted into Namecoin (or similar block chain, or block chain method, devised to record named data.) Once ensconced in the block chain, the device record can be extended and modified with attributes such as the PCR quotes, associated Bitcoin accounts or other data. It is anticipated that large data objects will be referenced with a hash and URL in the block chain, rather than directly. The enrollment agent, in conjunction with the device, controls the Namecoin account that can update this record. However, one could imagine a scenario for self-enrolled devices where the enrollment agent is also the device. Once enrolled a service can access the public keys of the device to validate and encrypt communications and cryptographic assurance that the associated attributes emanated from the device.

In a trusted execution environment, the features of device identity are provided while further extending the ability to execute code in isolation from the rest of the system. Embodiments of this invention provide a Bitcoin Services Component that is packaged for deployment in a variety of TEE environments. This results in a couple of critical enhancements to the execution of a transaction: (1) Code is signed and authenticated by a third party trusted application manager so it can't be tampered with. (2) Code is executed outside the host operating environment and is thus protected from malware. (3) Application data, beyond just keys, are never exposed outside of the TEE.

An enrolled device can build up a record of attributes that enable service providers to verify its state and context. Device attributes needn't include any PII to be useful. For example, a recent statement declaring a clean boot sequence can give a service provider some confidence that the machine is not compromised. Attributes that provide singular assertion of a fact can also be useful without divulging much PII, for example, the machine operator has been validated as over 21, or as a French citizen or member of an affinity club. In most cases, an interaction with a device is an opportunity to collect a statement of its boot integrity. This is nothing more than a collection of hashes that can be compared against the last boot statement. A machine that booted in a predictable way is believably more reliable than one who has changed BIOS or OS. In addition to PCR quotes, participating anti-virus software can deliver a statement that the machine was cleared as of the last scan.

In some embodiments, integration of the principles of Trusted Network Connect (TNC) would allow a full validation of an unknown client device prior to acceptance of a transaction. The client device being in a known good condition or state prior to the acceptance of a transaction is based on a third party's statement that the device is configured correctly. This type of verification addresses a broad range of cyber security controls that may be preferably required as part of any transaction processing system.

An exemplary embodiment is a computer-implemented method of verifying device integrity of a user device in a block chain communication network comprising in preparation for delivering an electronic transaction in the block chain network, implementing a device integrity verification process as part of the transaction including performing an internal validation of the integrity of the device execution environment from a root of trust in the user device; and requiring an electronic signature, such that a verification of the integrity of the signature is applied to the block chain transaction; wherein verification of the integrity of the signature is based on a determination of whether the execution environment of the device is in a known good condition including based on the integrity of the signature, allowing the transaction to proceed or requesting a remediation authority to verify that the electronic transaction as intended by the user is allowed to proceed even if it is determined that the execution environment of the device is not in a known good condition. In some embodiments verification of the integrity of the signature includes transmitting a root of trust instruction to the block chain network for processing, such that at least a portion of the block chain network responds by requiring multiple electronic signatures in order to accept the electronic transaction including creating within the execution environment of the device, an instruction from a root of trust in the user device; requiring a first electronic signature that corresponds to the root of trust instruction, such that a verification of the integrity of the signature is applied to the block chain transaction; and responding to the first electronic signature by verifying the integrity of the signature based on a determination of whether the execution environment of the device is in a known good condition including comparing the signature with a previously recorded reference value; if the signature matches the previously recorded reference value, then allowing the transaction to proceed; and if the signature does not match the previously recorded reference value, requesting a third party out of band process to verify that the electronic transaction as intended by the user is allowed to proceed even if it is determined that the execution environment of the device is not in a known good condition. In some embodiments, verifying the integrity of the signature includes the device providing the electronic signature based on a determination of whether the execution environment of the device is in a known good condition; allowing the transaction to proceed if the device provides the electronic signature; allowing the transaction as intended by the user to proceed even if it is determined that the execution environment of the device is not in a known good condition if the remediation authority provides the signature. Additionally, the out of band process may further include using an N or M cryptographic key function to confirm that at least one of an intent of the user meets predetermined requirements, or the device integrity meets predetermined requirements, or an additional process meets predetermined requirements. The reference value may be generated during a registration process performed by the owner of the device platform. The reference value may be generated based on a birth certificate assigned to the device, wherein the birth certificate is generated by the manufacturer or creator of the device, the manufacturer or creator of the execution environment of the device and/or the manufacturer or creator of an application on the device. The reference value may include a signature of at least one of the manufacturer or creator of the device, the manufacturer or creator of the execution environment of the device and/or the manufacturer or creator of an application on the device. The third party out of band process may return a token in response to the request to verify the transaction. Some embodiments may allow the electronic transaction to be completed within a certain period of time if the signature does not match the previously recorded reference value. Some embodiments may verify that the intended electronic transaction is allowed to proceed even if it is determined that the execution environment of the device is not in a known good condition is based on a period of time between the registration of the reference value and the transaction and/or the amount of the transaction. Transactions above a threshold amount may be allowed to proceed if the period of time meets predetermined requirements. Allowing the transaction above a certain amount may be based on a minimum number of previously allowed transactions. Some embodiments may further comprise using a display device indicating to the user whether device integrity meets minimum predetermined requirements and further actions to be taken. Other embodiments may further include notification to a third party of the transaction, wherein in response to the notification, the third party records the transaction and a state of the device. The third party may record measurements associated with the device integrity for future analysis of the transaction. In addition, assuring the privacy of the record may include cryptographically obfuscating the record such that the record is made available only to authorized third parties. Another exemplary embodiment is a computer-implemented system of verifying device integrity of a user device in a block chain communication network comprising a block chain communication network; a user device in the block chain network; an electronic transaction in the block chain network; a device verification process implemented as a part of the transaction in preparation for delivery of the electronic transaction in a block chain network, the implementation further comprising an internal validation of the integrity of the device execution environment performed from a root of trust in the device; an electronic signature, such that a verification of the integrity of the signature is applied to the block chain transaction; wherein verification of the integrity of the signature is based on a determination of whether the execution environment of the device is in a known good condition including: based on the integrity of the signature, allowing the transaction to proceed or requesting a remediation authority to verify that the electronic transaction as intended by the user is allowed to proceed even if it is determined that the execution environment of the device is not in a known good condition.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1A is an example digital processing environment in which embodiments of the present invention may be implemented.

FIG. 1B is a block diagram of any internal structure of a computer/computing node.

FIG. 2A is a block diagram showing an example device authentication system according to the invention.

FIG. 2B is a diagram showing an example device authentication system according to the invention.

FIG. 2C is a diagram of the components of an embodiment of the invention.

FIG. 2D is a diagram of the Authentication System Adaptor and its outward and inward looking interfaces.

FIG. 3A is a diagram of the sequence of packaging and delivering an instruction by the Encoder.

FIG. 3B is a diagram of the device enrollment process according to an embodiment of the invention.

### DETAILED DESCRIPTION

A description of example embodiments of the invention follows.

Embodiments of the present invention are systems and methods for attesting to device health prior to engaging in electronic transactions.

Block chain transactions do not have verification or cyber security controls on an unknown device performing the transactions. Therefore, a full validation of an unknown client device prior to acceptance of a block chain transaction would provide further security for block chain transactions.

Example embodiments may be founded on the principles of the Trusted Network Connect (TNC) standards under which the integrity of a device may be verified prior to actual enablement of the connection to a network switch. According to TNC, a device performs a series of measurements that are securely stored on the device. The measurements typically would include validation of the BIOS image, the operating system (OS) and any applications that need to be verified that they have not been altered. Upon connection to the network, the switch would perform a validation process verifying that the measurement data matches a reference value that was computed when the device was either previously connected or in a current known good condition or state. The Trusted Execution Environment (TEE) is also capable of self-measurement processes and remote attestation of the health of the device. In some preferred embodiments, the TNC system is based on the Trusted Computing Group (TCG) standards and typically the Trusted Platform Module (TPM) chip is integrated.

In some embodiments, automation of full device integrity verification is provided as part of a block chain transaction. In order to provide a validation of the device integrity, a device that is performing a block chain instruction would perform an internal validation of the integrity of the execution environment from a root of trust in the device at the initialization of the block chain transaction. The device would, with or without Human input create an instruction within the measured environment. This instruction would then be sent to the block chain network for processing. The block chain network will require multiple signatures to accept the transaction. The first signature would be the created root instruction itself that would have the verification of the signature applied to the transaction. The network then verifies the integrity signature of the execution environment by comparing it with a previously recorded Reference Value. If the signature matches the Reference Value the transaction is allowed to proceed. If the signature and Reference Value do not match then the system will require a third out of band process to be completed that would verify that the transaction intended is allowed to proceed even if the execution environment is not in a known good condition. Because, block chain transactions do not have any verification or cyber security controls on an unknown device performing a transaction, embodiments of the present invention would allow a full validation of an unknown client device being in a known good condition according to a third party's statement that the device is configured correctly prior to the acceptance of a transaction. Some embodiments of the present invention, therefore, can address a broad range of cyber security controls that should be required as part of any block chain transaction processing system.

Digital Processing Environment

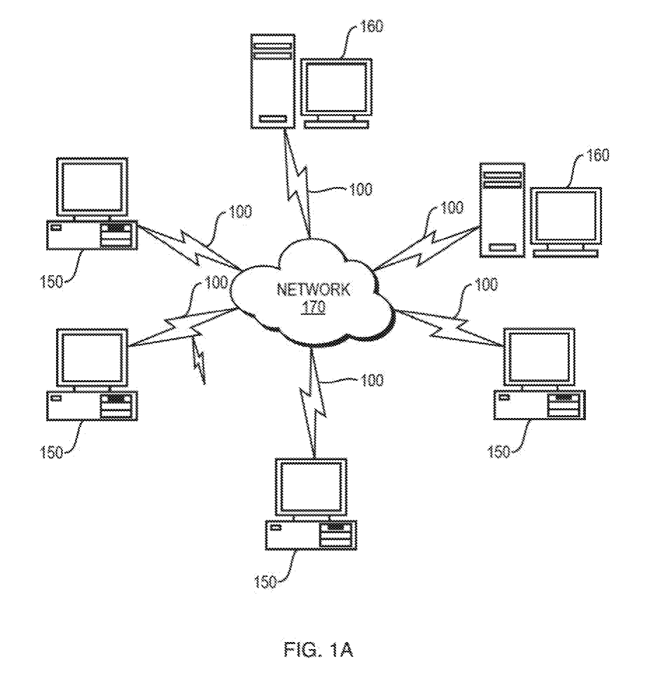

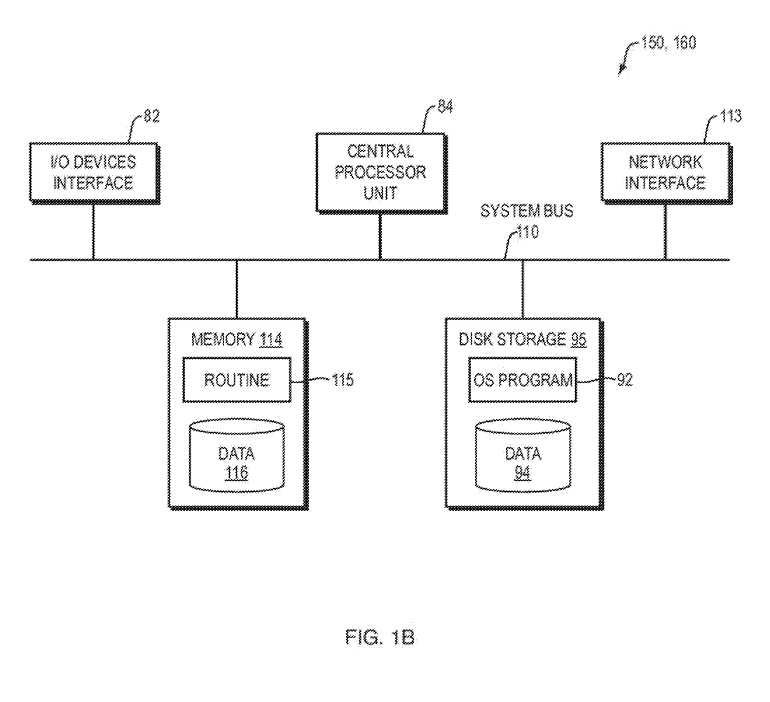

An example implementation of a system according to the invention for attesting to device health prior to engaging in transactions 100 may be implemented in a software, firmware, or hardware environment. FIG. 1A illustrates one such example digital processing environment in which embodiments of the present invention may be implemented. Client computers/devices 150 and server computers/devices 160 (or a cloud network 170) provide processing, storage, and input/output devices executing application programs and the like.

Client computers/devices 150 may be linked directly or through communications network 170 to other computing devices, including other client computers/devices 150 and server computer/devices 160. The communication network 170 can be part of a wireless or wired network, remote access network, a global network (i.e. Internet), a worldwide collection of computers, local area or wide area networks, and gateways, routers, and switches that currently use a variety of protocols (e.g. TCP/IP, Bluetooth®, RTM, etc.) to communicate with one another. The communication network 170 may also be a virtual private network (VPN) or an out-of-band network or both. The communication network 170 may take a variety of forms, including, but not limited to, a data network, voice network (e.g. land-line, mobile, etc.), audio network, video network, satellite network, radio network, and pager network. Other electronic device/computer networks architectures are also suitable.

Server computers 160 may be configured to provide a user device authentication system 100 which communicates with authenticators to confirm a requestor's identity prior to allowing the requestor to access resources protected by the authentication system. The server computers may not be separate server computers but part of cloud network 170.

FIG. 1B is a block diagram of any internal structure of a computer/computing node (e.g., client processor/device 150 or server computers 160) in the processing environment of FIG. 1A, which may be used to facilitate displaying audio, image, video or data signal information. Each computer 150, 160 in FIG. 1B contains a system bus 110, where a bus is a set of actual or virtual hardware lines used for data transfer among the components of a computer or processing system. The system bus 110 is essentially a shared conduit that connects different elements of a computer system (e.g., processor, disk storage, memory, input/output ports, etc.) that enables the transfer of data between elements.

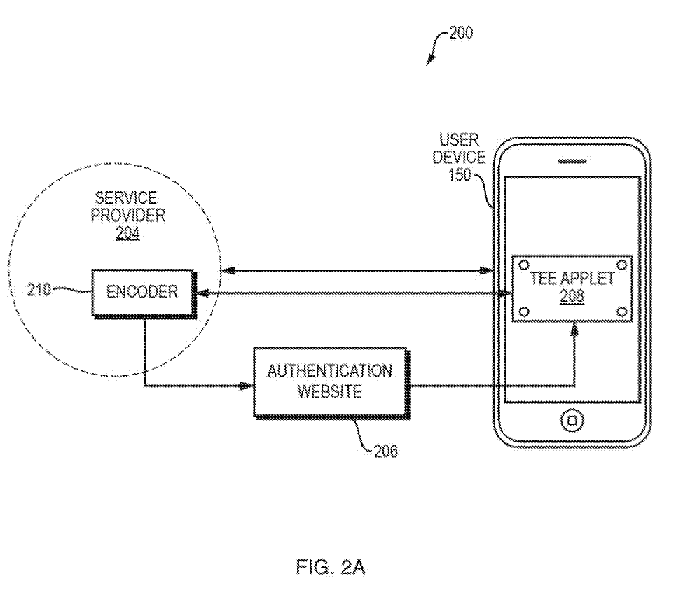

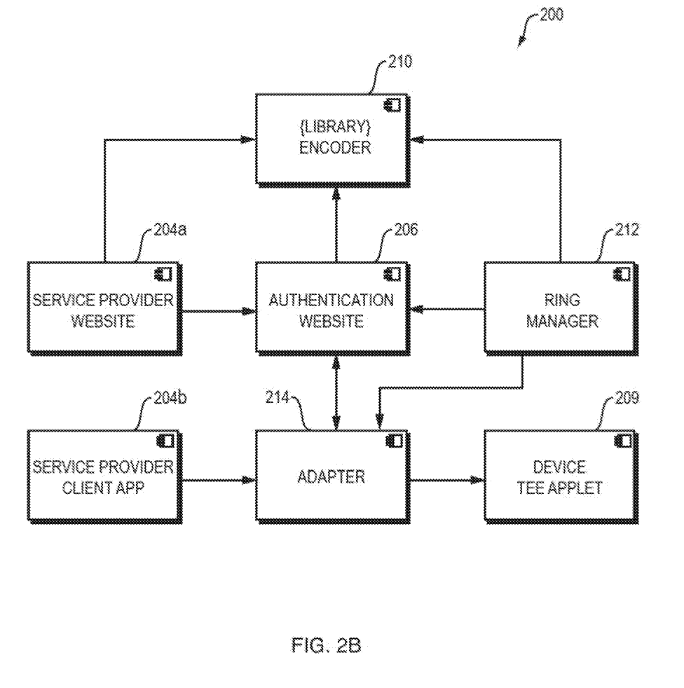

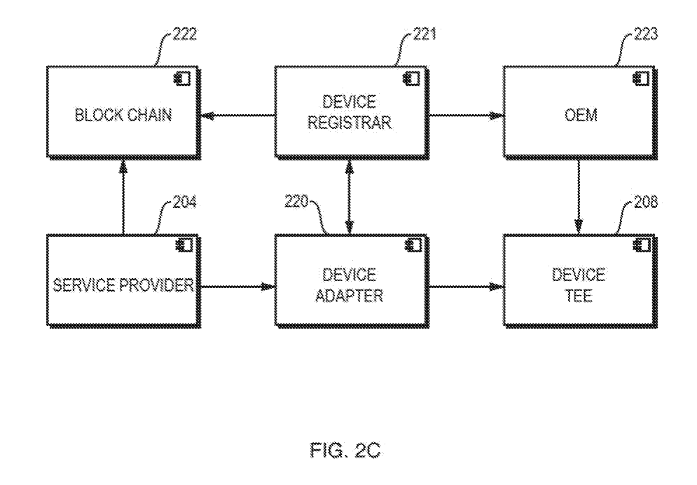

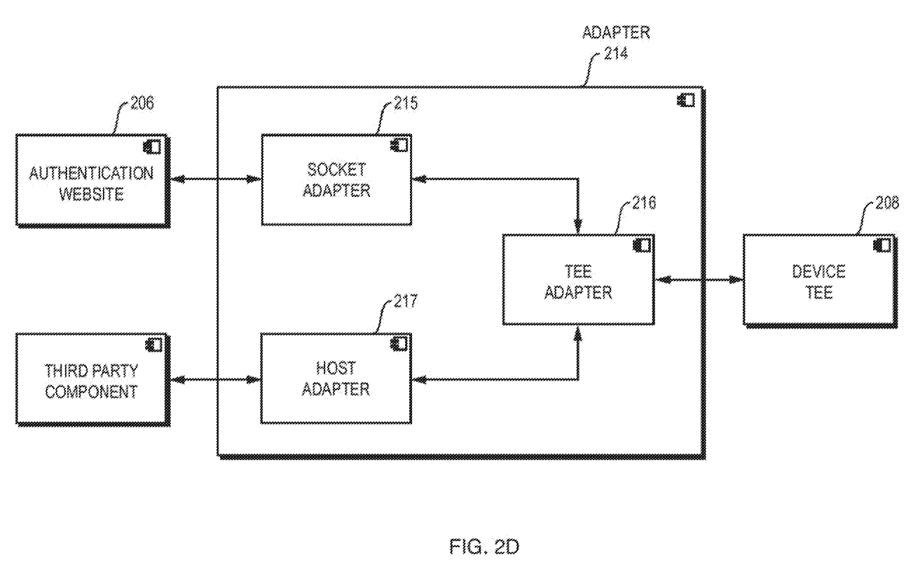

Attached to the system bus 110 is an I/O device interface 111 for connecting various input and output devices (e.g., keyboard, mouse, touch screen interface, displays, printers, speakers, audio inputs and outputs, video inputs and outputs, microphone jacks, etc.) to the computer 150, 160. A network interface 113 allows the computer to connect to various other devices attached to a network (for example the network illustrated at 170 of FIG. 1A). Memory 114 provides volatile storage for computer software instructions 115 and data 116 used to implement software implementations of device integrity attestation and authentication components of some embodiments of the present invention. Such device integrity attestation and authentication software components 115, 116 of the user authentication system 100 (e.g. encoder 210, Trusted Execution Environment (TEE) applet 208, authentication site 206 of FIG. 2A) described herein may be configured using any programming language, including any high-level, object-oriented programming language, such as Python.

In an example mobile implementation, a mobile agent implementation of the invention may be provided. A client server environment can be used to enable mobile security services using the server 190. It can use, for example, the XMPP protocol to tether a device authentication engine/agent 115 on the device 150 to a server 160. The server 160 can then issue commands to the mobile phone on request. The mobile user interface framework to access certain components of the system 100 may be based on XHP, Javelin and WURFL. In another example mobile implementation for OS X and iOS operating systems and their respective APIs, Cocoa and Cocoa Touch may be used to implement the client side components 115 using Objective-C or any other high-level programming language that adds Smalltalk-style messaging to the C programming language.

The system may also include instances of server processes on the server computers 160 that may comprise an authentication (or attestation) engine 240 (FIG. 2), which allow registering a user, selecting authenticators/attesters for confirming a requestor is a registered user, communicating with the authentications in regards to confirming a requestor's identity, and executing algorithms, such as statistical algorithms to compute confidence scores, to allow or deny the requestor access to resources protected by the system.

Disk storage 117 provides non-volatile storage for computer software instructions 115 (equivalently “OS program”) and data 116 used to implement embodiments of the system 100. The system may include disk storage accessible to the server computer 160. The server computer can maintain secure access to records related to the authentication of users registered with the system 100. Central processor unit 112 is also attached to the system bus 110 and provides for the execution of computer instructions.

In an example embodiment, the processor routines 115 and data 116 are computer program products. For example, if aspects of the authentication system 100 may include both server side and client side components.

In an example embodiment, authenticators/attesters may be contacted via instant messaging applications, video conferencing systems, VOIP systems, email systems, etc., all of which may be implemented, at least in part, in software 115, 116. In another example embodiment, the authentication engine/agent may be implemented as an application program interface (API), executable software component, or integrated component of the OS configured to authenticate users on a Trusted Platform Module (TPM) executing on a computing device 150.

Software implementations 115, 116 may be implemented as a computer readable medium capable of being stored on a storage device 117, which provides at least a portion of the software instructions for the user authentication system 100. Executing instances of respective software components of the user authentication system 100, such as instances of the authentication engine, may be implemented as computer program products 115, and can be installed by any suitable software installation procedure, as is well known in the art. In another embodiment, at least a portion of the system software instructions 115 may be downloaded over a cable, communication and/or wireless connection via, for example, a browser SSL session or through an app (whether executed from a mobile or other computing device). In other embodiments, the system 100 software components 115, may be implemented as a computer program propagated signal product embodied on a propagated signal on a propagation medium (e.g. a radio wave, an infrared wave, a laser wave, a sound wave, or an electrical wave propagated over a global network such as the Internet, or other networks. Such carrier medium or signal provides at least a portion of the software instructions for the present user device authentication system 100 of FIG. 2A.

Certain example embodiments of the invention are based on the premise that online services may be significantly enhanced when a device can be trusted to be what it says it is and to execute instructions exactly as asked. A service provider generally has confidence in its servers because they are under administrative control and usually protected physically. However, nearly all of the service provider's services are delivered to users through devices the service provider knows very little about and over which it rarely exerts any control.

Through the use of Trusted Execution technology, certain ineventive embodiments are able to provide a service provider with an oasis of trust in the unknown world of consumer devices. Basic capabilities such as “sign this”, or “decrypt this” are executed outside the murky world of the main OS. Keys can be generated and applied without ever being exposed in memory and can be attested to through a chain of endorsements traced back to the device manufacturer.

Certain aspects of the invention enable trust in devices. Some embodiments operate on the fundamental premise that a reliable relationship with a device can make for a much safer, easier and stronger relationship with an end user. Achieving this requires knowing with confidence that a device involved in a current transaction is the same device it was in previous transactions. It also requires assurance that a device will not leak protected information if it is requested to perform sensitive operations such as decryption or signing.

One example preferred embodiment includes device code executed in the Trusted Execution Environment (TEE). The TEE preferably is a hardware environment that runs small applets outside the main OS. This protects sensitive code and data from malware or snooping with purpose-built hardware governed by an ecosystem of endorsements, beginning with the device manufacturer.

Device Integrity Attestation/Authentication—Some Example Embodiments

FIG. 2A is a block diagram showing an example device authentication system according to the invention, with components 200. With these system components 200, web developers and app developers can make use of hardened encryption and identity keys in endpoint User Devices 205 through an application program interface (API). In addition, further services may be provided built on these system components 200 for device management, backup, attestation, etc. To support this system, the registration of identity keys and a set of device management services for attestation, backup and device grouping, are managed.

In a preferred example embodiment, it would be the intent of the system not to maintain mission critical data as in conventional approaches, but rather to provide a platform for seamless yet very secure connections between Service Providers 204 and User Devices 205. On one end of the system is the Encoder 210 which prepares an instruction for a User Device 205 and at the other is the Device Rivet which is the Trusted Execution Environment (TEE) applet 208 that can act on that instruction. A Protocol according to an embodiment of the invention defines how these instructions and replies are constructed.

The Device Rivet or TEE applet 208 preferably embodies the innovative binding between the physical and digital works. The Device Rivet or TEE applet 208 locks features of identity, transaction and attestation to the hardware of the Device 205.

The system 200, according to an embodiment of the invention shown in FIG. 2B, may use a secure socket to maintain a persistent connection with all devices. This channel is used for pairing and other administrative functions. Library code 209 may be provided to service providers for simplifying the construction and signing of an instruction. This Library 209, for example, could be implemented in a programming language, such as an object-oriented, high-level programming language with dynamic semantics like Python.

In one example preferred embodiment, the TEE may be implemented as a mobile phone hardware security chip separate execution environment that runs alongside the Rich Operating System and provides security services to that rich environment. The TEE offers an execution space that provides a higher level of security than a Rich OS. In another example embodiment, the TEE may be implemented as a virtual machine. While not as secure as a Secure Element (SE) (aka SIM), the security offered by the TEE is sufficient for some/many applications. In this way, the TEE can deliver a balance allowing for greater security than a Rich OS environment with considerably lower cost than an SE.

The Ring Manager 212 can be implemented as a service provided to end-users for managing collections (or Rings) of User Devices 205. Devices 205 may be grouped into a single identity and used to backup and endorse each other. Rings may be associated with other rings to create a network of devices. In some preferred embodiments, the rings are a collection of individual device public keys (as opposed to a new key). If there are not many shared devices in the environment, preferably the list of devices preferably may short because of the potential for increased computational and bandwidth resources may expended and introduce a time cost in order to encrypt a message with all of the public keys on a device list.

In a non-preferred example embodiment, a ring may be implemented as a shared private key on top of the unique private key of the Device 205. It should be noted, however, it is not typical to share a “private key”, nor would it be desirable to have a long-lived shared symmetric key.

One aspect of the system according to an embodiment of the invention enrolls a device and equips it with a service provider's keys. Inventive API's enable secure execution of a number of sensitive device-side transactions, including: getting a reliable and anonymous device id—on request, an embodiment of the invention will generate a signing key for a device. The public key is hashed into a string that can be used to identify and communicate with a device. The private key remains locked in the hardware and can only be applied on behalf of the service that requested the ID; getting a device to sign something—the private key of the device identity can be used to sign things proving that this particular device was involved. The signing ceremony is executed in secure hardware such that the key is never exposed to normal processing environment of the device; getting a device to encrypt something—an encryption key can be generated on request and applied to any blob of data. Encryption and decryption is triggered locally and takes place within the secure execution environment so as to protect the key; creating a Bitcoin account—the device can be asked to generate a new Bitcoin account using the random number generator (RNG) built into the TEE; signing a Bitcoin transaction—the device can apply its private Bitcoin account key to sign a transaction and then return it to the service provider; securing confirmation—newer TEE environments support trusted display and input in addition to trusted execution. Trusted display enables a simple confirmation message, such as “confirm transaction amount,” to be presented to an end user; joining devices to share and backup identities—most users have several devices. Certain embodiments of the invention enable multiple devices to be bound into a ring so they can interchangeably present themselves to a service provider on behalf of the user.

A Service Provider calls a Third Party Agent/Process to create hardware keys in a device. Different types of keys are available depending on the purpose, such as for crypto-coins or data encryption. Hardware keys are governed by simple usage rules established during creation. For example, a key may require that usage requests are signed by the Service Provider that created the key, or that the user confirms access through the Trusted User Interface (TUI).

A Device Rivet 208 will only respond to an instruction from a Service Provider 204 that has been “paired” with the Device 205. The Authentication Web Site 206 conducts the pairing ceremony as it is able to confirm the integrity and identity of both device and the service provider. When a Device 205 is paired it acquires the public key of the Service Provider 204, while the Service Provider gets a uniquely generated identity and public key for the Device 205.

While the Third Party Agent/Process supports local calls, ideally all instructions are signed by the Service Provider 204. This protects a device key from being applied by a rogue application. An Encoder 210 is provided to help prepare and sign device instructions on the application server.

There is a class of apps that benefit greatly from strong assurance of their origin and opaque separation from the execution of other apps. This is known as a Trusted Execution Environment or TEE. Unlike an app running on the primary OS and memory stack, an app running in a TEE has access to cryptographic primitives that can be exercised without snooping by the OS. On certain platforms, the app also has direct access to user input and display to ensure a private interaction with the operator of the device. While the technology has been pursued for well over a decade, it is only recently that devices with support for a TEE have become available. For example, Intel began delivery of commercial solutions in 2011 and Trustonic, an ARM joint venture, was launched in 2013.

Deploying an applet into a TEE is akin to delivering a dedicated hardware device. Execution and data are cryptographically isolated from any other function of the host. While most applications of Trusted Execution technology have been concerned with enterprise security or DRM, an embodiment of the invention instead provides an applet that is focused on the needs of common web services. Crypto currencies such as Bitcoin have highlighted the need for consumer key security.

An embodiment of the invention provides a native API that translates calls into a secure environment. While different TEE environments follow very different architectures, the API of an embodiment of the invention is designed to present a uniform interface to the application.

As with all TEE applets, TEE applets according to embodiments of the invention cannot be installed and initialized without a Trusted Application Manager, or TAM. The TAM plays a role akin to a certification authority (CA). A TAM secures a relationship with a device manufacturer and also signs all applets that may be loaded into the device. In this way the TAM expresses assurance about the provenance and integrity of both the applet and the TEE.

Device Integrity Attestation

Embodiments of the invention provide device integrity attestation by automating the assurance of device integrity against a known state as a signatory on a block chain transaction. The system implemented by an embodiment of the invention is comprised of the several components shown in FIG. 2C. A Device Adapter 220 is a software service running on an endpoint device that provides an interface to a Service Provider 204 application and integrates with the Device TEE 208. The Trusted Execution Environment (TEE—sometimes TrEE) is a mobile phone hardware security chip separate execution environment that runs alongside the Rich OS and provides security services to that rich environment. The TEE offers an execution space that provides a higher level of security than a Rich OS; though not as secure as a Secure Element (SE) (aka SIM), the security offered by the TEE is sufficient for some/many applications. In this way, the TEE delivers a balance allowing for greater security than a Rich OS environment with considerably lower cost than an SE. Another component, the Device TEE 208 is a software program that executes in a hardware secured TEE. The Device TEE 208 is specially designed to execute cryptographic functions without compromise from malware or even the device operator. Another component, the Device Registrar 221 is a service that registers a device into the block chain 222. A block chain 222 is used both to store device registration and attributes and to execute transactions. There may be different block chains. Another supporting component is a Service Provider 204 which is the application seeking to conduct a transaction with a device. OEM (Original Equipment Manufacturer) 223 is the entity that built the device and/or a Trusted Application Manager (TAM) authorized to cryptographically vouch for the provenance of the device.

According to an embodiment of the invention, when the Device Adapter 221 shown in FIG. 2C software runs for the first time it will ask the Device TEE 208 to generate a public/private key pair. The public key is signed by an endorsement key established during device manufacturing. This signed public key is sent to the Device Registrar 221 and validated with the OEM 223. Registration may involve confirmation from the device operator. Registration may involve endorsement at the point of sale in the presence of a clerk. The Registrar may ask the device for a Device Measurement Record which includes one or more of the following: a composite value of the Platform Configuration Registers (PCR's) generated by the boot process, BIOS Version, OS Version, GPS Location. This data is signed by the device private key. It is further signed by the Registrar. The resulting data set becomes the gold reference or Reference Value for future integrity checks. Confirmation from the device operator may be required in collecting the gold reference or Reference Value. This data set is posted into a public cryptographic ledger. The public record established cryptographic proof of the time of registration along with the endorsement of the registrar. The registration may further include attribute data, such as location or company name or device make/model. The registration may reference a signed document that sets out the policy terms of the registrar at the time of registration. The Device Registrar 221, or another trusted integrity server, creates a block chain account key (a public/private key pair) that can be referenced as a signatory in a multi-signature transaction on the block chain. A signatory the value represented in the block chain transaction cannot be spent or transferred unless co-signed by the Registrar.

To sign a transaction the integrity server expects a recent measurement from the device. This measurement may be requested directly of the Device Adaptor or fetched by the server through a persistent sockets connection with the device. The current measurement is compared against the gold measurement or Reference Value in the block chain. If the measurements match the transaction is signed. If the measurements match but the recent measurement is older than a specified time window, the request is rejected. If the measurements do not match, the request is rejected. If there is a rejection, the transaction may have been prepared with another manual signatory that can be asked to override the rejection. If the measurements do not match, the device may be put through a registration renewal where a new measurement is gathered. Every time a measurement matches, the device registration record can be updated with a success count. The integrity server may be given policy rules that will accept a measurement which doesn't match if the problem is not deemed severe in light of other matching measurements or attributes.

A system, according to an embodiment of the invention, may be implemented with a collection of trusted devices rather than an integrity server to do the work of matching measurements and signing the transaction. The system may match integrity measurements directly during transaction processing using features built into a smart block chain system such as that being developed by Ethereum.

Device Integrity Attestation—Authentication Web Site

In an example embodiment, Authentication Web Site 206 may be a JSON API written in Python, which uses the Third Party Agent/Process private key to enroll the identity keys of Devices 205 and Service Providers 204. During enrollment, the public key of the User Device 205 or Service Provider 204 is recorded by the TEE applet 208. Enrollment enables the TEE applet 208 to pair a Device 205 with a Service Provider 204. The result of pairing is that a User Device 205 has a service public key, endorsed by a Third Party Agent/Process and can therefore respond to Service Provider 204 instructions.

The Protocol according to an embodiment of the invention specifies the structure of an instruction and the signing/encryption that must be applied for the Device 205 to accept the instruction. The instruction itself may, for instance, be prepared as a C structure that contains the instruction code, version data and payload. The entire structure preferably is signed by the service provider key and delivered to the device TEE applet 208 by calling a device local command.

Preferably, every User Device 205 should present unique identity credentials. Devices may join a ring so as to act as a singular entity. In one embodiment, a Device 205 can support group ID's that are locally stored as a list, but publicly translate into cross-platform authentication. The TEE Adapter 216 may be configured as the interface between the Device Rivet/TEE applet 208 bolted into the TEE and the outside world of partner apps and online services. In implementation, it can manifest in one or more diverse forms, which would be at least partially dictated by the basic capabilities across devices, hardware support and OS architecture.

Device Integrity Attestation—Authentication System Adaptor

The Authentication System Adaptor 214 is composed of outward and inward looking interfaces as shown in FIG. 2D. The inward looking interface, the TEE Adapter 216, handles proprietary communications with the Device Rivet 208. The Host Adaptor 217 is provided to expose services to third-party applications. The Host Adaptor 217 presents the interface of the Authentication System Adaptor 214 through different local contexts, such as browsers or system services. Multiple realizations for diverse contexts are anticipated though initially this may be an Android service and a windows com process. The Socket Adaptor 215 connects the client environment Authentication Web Site 206. The TEE Adaptor 216 component is the proprietary glue that pipes commands into the Device Rivet 208. In an Android implementation the Authentication System Adaptor 214 may manifest as an Android NDK service app and may be configured to launch at boot. The Authentication System Adaptor 214 prepares message buffers that are piped to the Device Rivet 208 and then synchronously awaits notification of a response event. The Host Adaptor 217 is primarily there to isolate the TEE Adapter 216 from the host environment. The Host Adaptor 217 operates in a potentially hostile environment. There will therefore typically be limited assurance that the client has not been compromised. The Host Adaptor's role is therefore primarily to facilitate easy access to the Device Rivet 208. Instructions from a Service Provider 204 intended for the Device Rivet 208 will be signed by the Service Provider 204 and then passed through to the TEE Adapter 216 and Device Rivet 208.

First Service Provider Registered to a Device

According to an example embodiment, the Authentication Web Site 206 is the first service provider registered to a Device 205. The Authentication Web Site 206 has the special capability of being able to pair additional service providers with that Device 205. Communications with the Authentication Web Site 206 may be handled through the web API and should be authenticated. In one example, this is implemented with an API key. In a preferred example embodiment, this is implemented using an SSL key swap. In some embodiments, all requests will be signed.

The relationship with devices may be dependent on being able to sign instructions with the private key. Such a private key is highly sensitive and is protected. Preferably, the private key is encased in an HSM.

In some embodiments, multiple keys are used, such that if one is compromised the whole system is not lost. This should, for example, should make it more difficult for an attacker to know which devices are connected with a compromised key. Furthermore, the system 200 is preferably in near constant contact with all Devices 205 through the Socket Adapter 215 shown in FIG. 2C, which can facilitate frequent rotation of the keys.

The Authentication Web Site 206 may comprise several sub-components. A Device ID is the unique identifier, in a UUID, assigned to a device by the Authentication Web Site 206 or other Registration Agent. An ephemeral pointer, Device Pointer, may be provided to a device 150 that can be requested by any local application. The Device Pointer can identify a current socket session to the Authentication Web Site 206 and therefore can be used to establish a device communication channel and to look up the permanent identifier, the Device ID. The root of a device registration includes a unique, anonymous identifier, a registration date, a public key paired to a private key held in the device hardware and an endorsement signature from the Registration Agent. This information is recorded in the Device Registration Record. The TEE applet 208 embodies the binding between the physical and digital works. The Device Rivet 209 locks features of identity, transaction and attestation to hardware.

Protocol for Processing Instructions

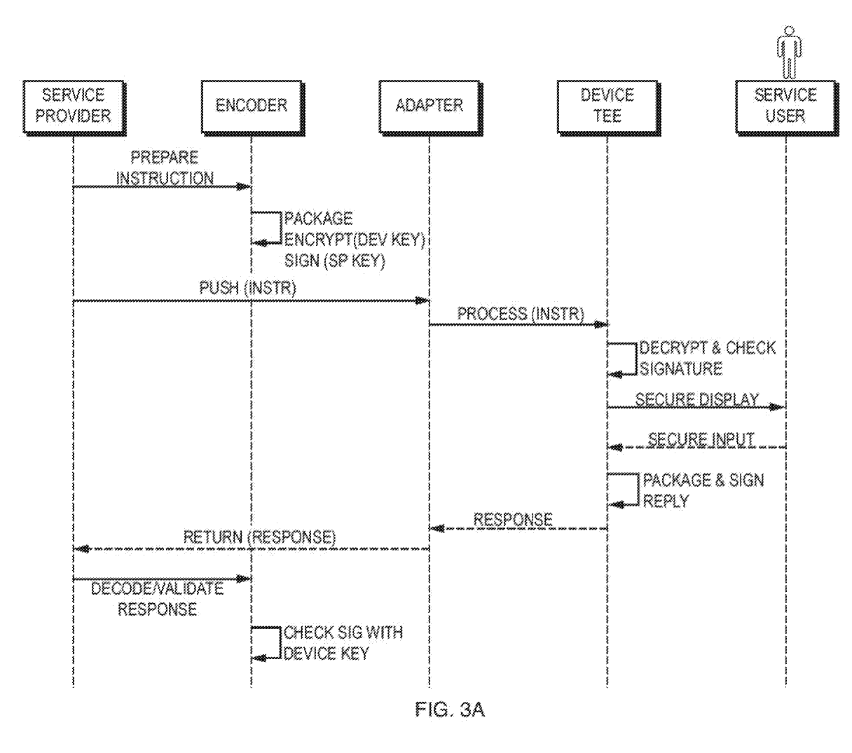

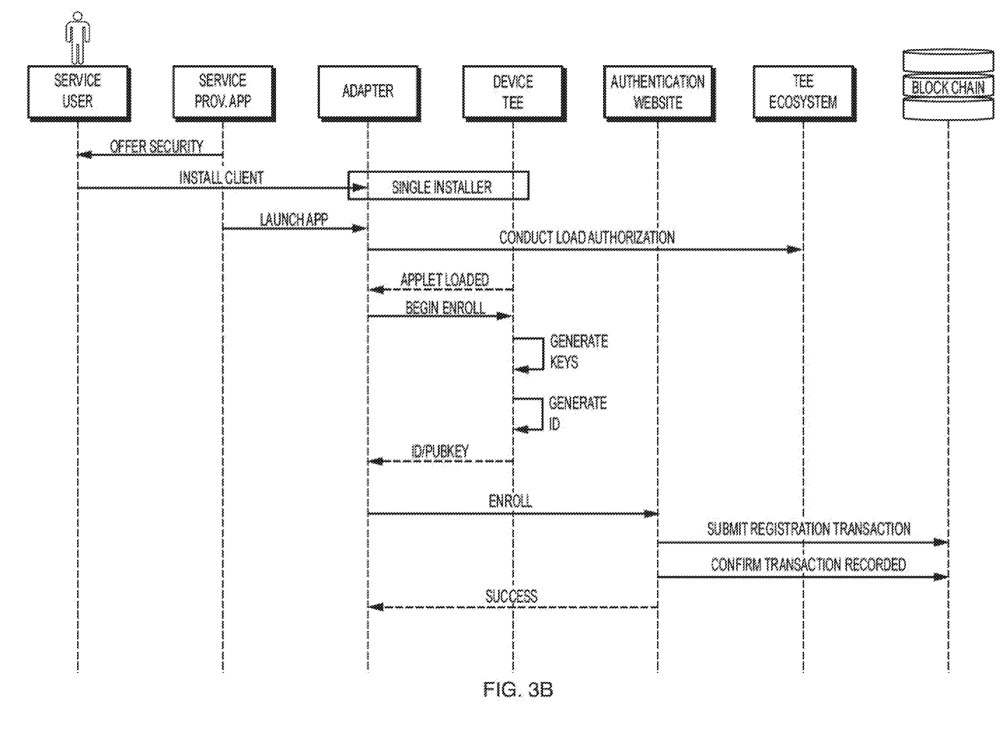

The counterpart to the Device Rivet 209 is the Encoder 210. The Encoder 210 prepares a command to be executed by a specific device which is signed and/or encrypted by the Service Provider 204. The Service Provider public keys are preloaded into the device during a pairing process conducted by Authentication Web Site 206. This allows the Device Rivet 209 to validate the origin of the request, and if needed decrypt the contents of the instruction. The sequence of packaging and delivering an instruction is shown in FIG. 3A. The Service Provider 204 generates an Instruction Record with the help of the Encoder 210 libraries. The instruction includes the type, the target device and payload. The instruction may be encoded with the device key and must be signed by the service provider key. The device key is fetched from the Authentication Web Site 206, or directly from the block chain, by looking up the Device Registration Record.

Protocol for Enrolling the Device

Device enrollment or creation of a birth certificate for a device on the block chain is essential to example embodiments of the invention. The enrollment process, shown in FIG. 3B, must be hassle free or even transparent to the user. Ideally, a fully reputable Device ID would include personalization of the relationship between a device and a user with a PIN or other memory test; as well as legal binding between the user and the device, for example, by registering the device in presence of a sales clerk. It would look up the endorsement keys of the OEM that manufactured the device to ensure provenance. It also might include training on the purpose, power and anonymity of device registration. We can start with just creating the ID transparently. Because of this variability in the context of the registration, the Registration Agent should record the context of enrollment to ensure that trust is being extended where it's due. For example, testing an OEM endorsement key makes it vastly more certain that the Device Rivet is operating in a proper TEE.

In an example embodiment shown in FIG. 2C, when the Device Adapter 220 software runs for the first time it will ask the Device TEE 208 to generate a public/private key pair. The public key is signed by an endorsement key established during device manufacturing. This signed public key is sent to the Device Registrar 221 and validated with the OEM 223. Registration may involve confirmation from the device operator or registration may involve endorsement at the point of sale in the presence of a clerk. The Registrar 221 will ask the device for a Device Measurement Record which includes one or more of the following: a composite value of the Platform Configuration Registers (PCR's) generated by the boot process, BIOS Version, OS Version, GPS Location, BIOS identifier, a network interface identifier, attributes about the Device, such as number of files, size of files, directories, indexes and data/search tree structures, processor identifying number of the Device, or other such information. This data is signed by the device private key and may be further signed by the Registrar 221. The resulting data set becomes the gold reference for future integrity checks. Confirmation from the device operator may be required in collecting the gold reference. This data set is posted into a public cryptographic ledger, such as Namecoin. The public record established cryptographic proof of the time of registration along with the endorsement of the registrar. The registration may further include other attribute data, such as location or company name or device make/model. The registration may reference a signed document that sets out the policy terms of the registrar at the time of registration. The Device Registrar 221, or another trusted integrity server, creates a block chain account key (a public/private key pair) that can be referenced as a signatory in a multisig transaction on the block chain. A signatory value represented in the block chain transaction cannot be spent/transferred unless co-signed by the Registrar 221. To sign a transaction the integrity server expects a recent measurement from the device. This measurement may be requested directly of the device adapter or fetched by the server through a persistent sockets connection with the device. The current measurement is compared against the gold measurement in the block chain. If the measurements match the transaction is signed, if the measurements match but the recent measurement is older than a specified time window, the request is rejected. If the measurements do not match the request is rejected. If there is a rejection, the transaction may have been prepared with another manual signatory that can be asked to override the rejection. If the measurements do not match the device may be put through a registration renewal where a new measurement is gathered. Every time a measurement matches, the device registration record can be updated with a success count. The integrity server may be given policy rules that will accept a measurement which does not match if the problem is not deemed severe in light of other matching measurements or attributes. This system may be implemented with a collection of trusted devices rather than an integrity server to do the work of matching measurements and signing the transaction. This system may match integrity measurements directly during transaction processing using features built into a smart block chain system such as that being developed by Ethereum.

Birth Certificate for a Device on the Block Chain

An embodiment may be a method for creating a birth certificate for a user device in a block chain communication network comprising: establishing a device identity for the user device by generating a public/private key pair that is locked to the user device; signing of the public key of the device by an endorsement key established during manufacturing or creation of the device, manufacturing or creation of the execution environment of the device and/or manufacturing or creation of an application on the device; and enrolling the device with a trusted third party including: requesting and obtaining the generated public key from the device; requesting and obtaining a device measurement record of the device containing attributes related to the device Platform Configuration Registers (PCR), BIOS, OS and/or GPS; endorsing of the device measurement record by the third party and the device; and registering the device into the block chain including posting the endorsed device measurement record into a public cryptographic ledger; and creating a block chain account key pair that can be referenced as a signatory in a multi signature transaction on the block chain. In some embodiments the method may include enrolling the device with a third party is at the request of the first service provider seeking to pair with the device. In some embodiments, enrolling the device may be provided as a service. Endorsing of the device measurement record by the device may include signing of the record by the device private key. Endorsing of the device measurement record by the third party may be provided as a service. The registration may further include signing of a document that sets out the policy terms of the registration provider at the time of registration. The public cryptographic ledger may be Namecoin. The endorsed device measurement record may establish a Reference Value for transactions between a service provider and the device. Additionally, confirmation by the device operator is required to obtain the device measurement record of the device attributes from the device. The device attributes may further include location, company name and/or device make/model. Further, the transaction between a service provider and the device may require the device to generate and provide a device measurement record that is compared to the established Reference Value for the device. In other embodiments, the transaction is allowed if the comparison results in a match or the transaction is rejected if the comparison results in no match or the transaction is rejected if the comparison results in a match and the record provided by the device is older than a specified time window or the device is required to re-create its birth certificate if the comparison results in no match. Additionally, registering the device into the block chain may further include creating a device registration record that is updated with a success count if the comparison results in a match. The comparison may be implemented by a collection of trusted devices. The entity performing the comparison may be independent of the entity performing the registration.

Another embodiment may be a system comprising a block chain communication network; a user device in the block chain network; a trusted third party; and a system for creating a birth certificate for the user device, said system configured to establish a device identity for the user device by generating a public/private key pair that is locked to the user device; sign the public key of the device using an endorsement key established during manufacturing or creation of the device, manufacturing or creation of the execution environment of the device and/or manufacturing or creation of an application on the device; and enroll the device with the trusted third party by: requesting and obtaining the generated public key from the device; requesting and obtaining a device measurement record of the device containing attributes related to the device Platform Configuration Registers (PCR), BIOS, OS and/or GPS; endorsing of the device measurement record by the third party and the device; and registering the device into the block chain by posting the endorsed device measurement record into a public cryptographic ledger; and creating a block chain account key pair that can be referenced as a signatory in a multi signature transaction on the block chain.

Using Transactions on the Block Chain to Accumulate Ownership Rights

A bitcoin Wallet functions similarly to a bank account and can be used to receive and store bitcoins as well as transfer them to others in the form of electronic transaction in the Bitcoin block chain. A bitcoin address is a unique identifier that allows a user to receive bitcoins. Bitcoins are transferred by sending them to a bitcoin address. The transactions in the bitcoin block chain are usually free. However, transactions that send and receive bitcoins using a large number of addresses will usually incur a transaction fee. A Wallet stores the private keys so that the user can access bitcoin addresses.

Systems and methods may be provided whereby a transaction on the block chain accumulates or achieves an ownership right.

A service may be provided whereby a bitcoin transaction accumulates to a new license right. This would be done by integrating a smart contract with attribute information in the transaction record that would identify the chain of transactions that accumulate to a right. Ultimately this right would be bound to the original Wallet address. Every time a specific item is purchased it would incorporate the last transaction as part of the attribute data of the current transaction assuring that the accumulation of transactions could be quickly and efficiently verified by reading the information on the block chain. The act of performing many small transactions on the block chain would enable an account to easily accumulate to an ownership right or a replay right. Once a specific level is reached, the accumulation would stop and a persistent right would be written to the block chain.

Some embodiments may include systems and methods for attesting to device health prior to engaging in electronic transactions.

This would be done by integrating a smart contract with attribute information in the transaction record that would identify the chain of transactions that accumulate to a right. Ultimately this right would be bound to the original Wallet address. Every time a specific item is purchased it would incorporate the last transaction as part of the attribute data of the current transaction assuring that the accumulation of transactions could be quickly and efficiently verified by reading the information on the block chain. The act of performing many small transactions on the block chain would enable an account to easily accumulate to an ownership right or a replay right. Once a specific level is reached, the accumulation would stop and a persistent right would be written to the block chain.

A system for may be provided for accumulating a value attached to transactions in a block chain communication network associated with a bitcoin account, the system comprising a block chain communication network; an electronic transaction in the block chain network; a bitcoin account; a transaction record associated with the bitcoin account; a transaction interrogation process implemented as a part of executing the electronic transaction in a block chain network. The implementation may further comprise a checking of the transaction record for the existence of a previous transaction associated with the account; and based on the existence of a previous transaction: obtain an accumulated value attached to the previous transaction; increment the obtained accumulated value; attach the incremented accumulated value to the transaction in the transaction record; and apply the incremented accumulated value to the transaction.

The implementation of the transaction interrogation process may further comprise setting a plurality of charges incurred for executing the electronic transaction to zero and indicating the achievement of a Right associated with the account, based on the incremented accumulated value reaching or exceeding a predetermined maximum accumulated transaction value.

The implementation of the transaction interrogation process may further comprise creating a new transaction record associated with the account; and storing an indication of the achieved Right in the newly created transaction record.

The electronic transaction may be associated with a specific Item, the transactions in the transaction record associated with the account form a chain with cryptographic assurance and the implementation of the transaction interrogation process may further comprise: allowing a user to query the last transaction recorded in the transaction record associated with the account; and calculating a level of expenditure for the specific Item based on cryptographic assurance of the formed chain.

Applying the accumulated value to the transaction may include associating the achieved Right with a cryptographic key; storing the key in a tamper resistant storage; obtaining a set of transactions contributing to the accumulated value associated with the achieved Right; and verifying the set of transactions prior to applying the accumulated value to the transaction.

In some systems, the set of transactions must be completed within a specific period of time in order to contribute to the achievement of the Right. The achieved Right expires after a specific period of time and/or expires based on the lack of use of the Right. The achieved Right is used as part of a multiple signature transaction to enable the purchase of additional transactions requiring an indication of the achieved Right.

In some systems, the transaction is associated with a single Item and involves two achieved Rights and the accumulated values associated with the Rights are cryptograhically merged to result in a single accumulated value.

Assured Computer Instructions to Cloud Services and Peer Services

The current state of computing is based on an authentication model in which devices connect to a cloud service like Twitter and then assume that the follow-on data is correct. Encrypted transport is commonly used and the assurance model is based on assuring the whole computer that sends the data. Technologies like anti-virus and integrity validation are provided for the host system. An assumption is made that the complex system is okay and to trust the critical data delivered.

Authentication may be augmented with assured computer instructions that are formed within the local device from both remote sources to assure these instructions are correct and to then deliver these instruction to remote services for processing. The system may collect data from user input, device input, remote system input and then provide a secure mechanism for the user to confirm this is the intended transaction to be performed. The cloud service receives this assured instruction and verifies that the elements of the transaction are correct. The verification process may also impose local or remote policies that are verified prior to the transaction being accepted for processing. The resulting data can then be logged.

In a general purpose computing device, typically, authentication is used to connect to critical services. Even with strong authentication there is no assurance that the information sent to the cloud is the information the user intends. Malware can find many ways to alter the data and result in the theft or compromise of sensitive data. The purpose of this invention is to collect a number of sources of both local and remote data to assure that the information provided is the data that is intended. Certain data could also be locally masked to assure a process has been completed but the detailed private information remains masked. Services can then verify the transactions are intended and incorporate a number of additional process steps internally and externally that are controlled by the user. This can assure logging and additional verification to assure the transaction is correct. This can be used in financial systems but also to control the internet of things from door locks to medical devices.

In some systems, a secure sub system is used for assembling a secure instruction for delivery to another computer system. The secure sub system collects and appends additional information such as time, location, identity, compliance or other critical data locally or remotely and provide the user a mechanism to securely confirm the instruction prior to the instruction being signed and then sent.

In some systems, when the protected instruction is received, it is verified prior to being processed. Verification can be done locally or remotely and may include additional user verification, confirmation or signature from logging systems, other critical process steps, location or time.

In some systems, local data could be tokenized to protect privacy. For example, the users phone number could be used to say they are a specific provider's customer and in good standing but all that is passed on is the good standing status and not the users name or phone number. This is done by contacting the provider locally and having the confirmation data include a provider transaction identity that can be remotely verified.

Some systems may leverage the local attestation data to assure the isolated execution environment can be prove that it is in a known condition at the time of the transaction.

Systems may be configured with a logic script that is cryptographically assured to provide the policy required for a specific transaction. The script validation may be included as part of the transaction verification data.

Systems may include local or remote approvals prior to the transaction being released (i.e. multi signal on the client side). The systems may receive real time data that is locally assured and then modified so the instruction is a delta to a real time state, for example, to increase speed of a pump. In some systems, the verifying device assures that the transaction came from a known source that meets the minimum number of parameters. In other systems, the receiving device additionally verifies local or remote information.

While this invention has been particularly shown and described with references to example embodiments thereof, it will be understood by those skilled in the art that various changes in form and details may be made therein without departing from the scope of the invention encompassed by the appended claims.

1. A computer-implemented method of verifying device integrity of a user device in a block chain communication network comprising:
in preparation for delivering an electronic transaction in the block chain network, implementing a device integrity verification process as part of the transaction including:
performing an internal validation of the integrity of the device execution environment from a root of trust in the user device; and
requiring an electronic signature, such that a verification of the integrity of the signature is applied to the block chain transaction,
the verification of the integrity of the signature being based on a determination of whether the execution environment of the device is in a known good condition including
based on the integrity of the signature, allowing the transaction to proceed or requesting a remediation authority to verify that the electronic transaction as intended by the user is allowed to proceed even if it is determined that the execution environment of the device is not in a known good condition.

2. The method of claim 1 wherein verification of the integrity of the signature includes:
transmitting a root of trust instruction to the block chain network for processing, such that at least a portion of the block chain network responds by requiring multiple electronic signatures in order to accept the electronic transaction including:
creating within the execution environment of the device, an instruction from a root of trust in the user device;
requiring a first electronic signature that corresponds to the root of trust instruction, such that a verification of the integrity of the signature is applied to the block chain transaction; and
responding to the first electronic signature by verifying the integrity of the signature based on a determination of whether the execution environment of the device is in a known good condition including:
comparing the signature with a previously recorded reference value;
if the signature matches the previously recorded reference value, then allowing the transaction to proceed; and
if the signature does not match the previously recorded reference value, requesting a third party out of band process to verify that the electronic transaction as intended by the user is allowed to proceed even if it is determined that the execution environment of the device is not in a known good condition.

3. The method of claim 1 wherein verifying the integrity of the signature includes:
the device providing the electronic signature based on a determination of whether the execution environment of the device is in a known good condition;
allowing the transaction to proceed if the device provides the electronic signature;
allowing the transaction as intended by the user to proceed even if it is determined that the execution environment of the device is not in a known good condition if the remediation authority provides the signature.

4. The method as in claim 2 wherein the out of band process further includes using an N or M cryptographic key function to confirm that at least one of: an intent of the user meets predetermined requirements, or the device integrity meets predetermined requirements, or an additional process meets predetermined requirements.

5. The method as in claim 2 wherein the reference value is generated during a registration process performed by the owner of the device platform.

6. The method as in claim 2 wherein the reference value is generated based on a birth certificate assigned to the device, wherein the birth certificate is generated by the manufacturer or creator of the device, the manufacturer or creator of the execution environment of the device and/or the manufacturer or creator of an application on the device.

7. The method as in claim 2 wherein the reference value includes a signature of at least one of the manufacturer or creator of the device, the manufacturer or creator of the execution environment of the device and/or the manufacturer or creator of an application on the device.

8. The method as in claim 2 wherein the third party out of band process returns a token in response to the request to verify the transaction.

9. The method as in claim 2 further allowing the electronic transaction to be completed within a certain period of time if the signature does not match the previously recorded reference value.

10. The method as in claim 2 wherein verifying that the intended electronic transaction is allowed to proceed even if it is determined that the execution environment of the device is not in a known good condition is based on a period of time between the registration of the reference value and the transaction and/or the amount of the transaction.

11. The method as in claim 10 wherein transactions above a threshold amount are allowed to proceed if the period of time meets predetermined requirements.

12. The method as in claim 11 wherein allowing the transaction above a certain amount is based on a minimum number of previously allowed transactions.

13. The method as in claim 1 further comprising using a display device indicating to the user whether device integrity meets minimum predetermined requirements and further actions to be taken.

14. The method as in claim 1 further including notification to a third party of the transaction, wherein in response to the notification, the third party records the transaction and a state of the device.

15. The method as in claim 14 wherein the third party records measurements associated with the device integrity for future analysis of the transaction.

16. The method as in claim 14 further assuring the privacy of the record including cryptographically obfuscating the record such that the record is made available only to authorized third parties.

17. A computer-implemented system of verifying device integrity of a user device in a block chain communication network comprising:
a block chain communication network;
a user device in the block chain network;
an electronic transaction in the block chain network;
a device verification process implemented as a part of the transaction in preparation for delivery of the electronic transaction in a block chain network, the implementation further comprising:
an internal validation of the integrity of the device execution environment performed from a root of trust in the device;
an electronic signature, such that a verification of the integrity of the signature is applied to the block chain transaction,
wherein the verification of the integrity of the signature being based on a determination of whether the execution environment of the device is in a known good condition including
based on the integrity of the signature, allowing the transaction to proceed or requesting a remediation authority to verify that the electronic transaction as intended by the user is allowed to proceed even if it is determined that the execution environment of the device is not in a known good condition.

18. The method as in claim 1 further accumulating a value attached to transactions in the block chain communication network associated with a bitcoin account comprising:
implementing a transaction interrogation process as part of executing the electronic transaction in the block chain network, the implementation further comprising:
checking a transaction record for the record of a previous transaction associated with the account, the transaction record associated with the bitcoin account; and
based on the existence of a previous transaction:
obtaining an accumulated value attached to the previous transaction;
incrementing the obtained accumulated value;
attaching the incremented accumulated value to the transaction in the transaction record; and
applying the incremented accumulated value to the transaction.

19. The method as in claim 18, the transaction interrogation process further comprising:
setting a plurality of charges incurred for executing the electronic transaction to zero and indicating the achievement of a Right associated with the account, based on the incremented value reaching or exceeding a predetermined maximum accumulated transaction value; and
wherein applying the accumulated value of the transaction includes:
associating the achieved Right with a cryptographic key;
storing the key in a tamper resistant storage;
obtaining a set of transaction contributing to the accumulated value associated with the achieved Right; and
verifying the set of transactions prior to applying the accumulated value to the transaction.

20. The method as in claim 19, the transaction interrogation process further comprising:
creating a new transaction record associated with the account;
storing an indication of the achieved Right in the newly created transaction record;
allowing a user to query the last transaction recorded in the transaction record associated with the account, wherein the electronic transaction is associated with a specific Item and the transactions in the transaction record associated with the account form a chain with cryptographic assurance; and
calculating a level of expenditure for the specific Item based on cryptographic assurance of the formed chain.
